(19) United States
(12) Patent Application Publication
(10) Pub. No.: US 2012/0030041 A1
(43) Pub. Date: Feb. 2, 2012

(54) CONTENT INTERACTIVITY GATEWAY AND METHOD OF USE THEREWITH

(75) Inventors: Jack Wolosewicz, San Francisco, CA (US); Erich Breisacher, San Francisco, CA (US)

(73) Assignee: Media Claw, Corp., San Francisco, CA (US)

(21) Appl. No.: 13/271,208

(22) Filed: Oct. 11, 2011

Related U.S. Application Data
(63) Continuation-in-part of application No. 11/548,039, filed on Oct. 10, 2006.
(60) Provisional application No. 60/739,812, filed on Nov. 23, 2005.
(60) Provisional application No. 60/776,128, filed on Feb. 23, 2006.

(51) Int. Cl. G06Q 30/00; G06F 3/048

(52) U.S. Cl. 705/14.73; 715/723

(57) ABSTRACT

A method includes receiving, by way of a host device, a request to pause playback of content. The method further includes the host device displaying an input area. Also included is the host device accepting an annotation entered into the input area by the user and conveying the annotation to a content interactivity gateway.

### RELATED INVENTIONS

The present invention is a continuation-in-part of U.S. application Ser. No. 11/548,039 filed on Oct. 10, 2006 and titled “Content Interactivity Gateway” by Jack Wolosewicz et al., which claims the benefit of priority from U.S. Provisional Patent Application No. 60/739,812, for “Content Protection Through The Use of Watermarking,” filed on Nov. 23, 2005 and U.S. Provisional Patent Application No. 60/776,128, for “Video and Audio Content Broadcast Interactivity Through The Use of Audio Watermarking,” filed on Feb. 23, 2006. Each of these provisional patent applications is incorporated by reference herein in its entirety.

### FIELD OF THE INVENTION

The subject matter disclosed herein relates to user interaction with a content delivery system.

### BACKGROUND

As content delivery systems continue to increase in popularity and availability, there is a growing desire for consumers to interact with content in a more personalized manner. Such interaction not only enhances the content consumer's experience, but may also increase the ability of the content provider to monetize the content development and delivery process. As a result, high-quality content may be delivered to consumers at a reduced cost while increasing the consumer's choices in purchasing goods and services that may be relevant to the delivered content

### SUMMARY OF THE INVENTION

In an implementation, a host device receives a request to pause playback of content. The host device displays a user interface element at a user-selectable location on the display of the host device. When the user interface element is positioned on the display, contextual information in a stacked configuration is displayed in addition to an input area. In an implementation, an input area allows the user to enter an annotation, which is conveyed from the host device to a content interactivity gateway.

In another implementation, a content interactivity gateway receives an indication that a first host device has paused content playback along with an indication that a user interface element has been selected on the first host device. The gateway may also receive an annotation relevant to the selected user interface element entered during the pause. The gateway may employ a curator function to determine that the received annotation is appropriate or inappropriate. Inappropriate annotations may then be deleted. In an implementation, appropriate annotations are conveyed to other host devices along with advertising that may be relevant to content being presented on the host device.

### BRIEF DESCRIPTION OF THE DRAWINGS

Non-limiting and non-exhaustive aspects are described with reference to the following figures, wherein like reference numerals refer to like parts throughout the various figures.

FIG. 1A is a block diagram of an exemplary content interactivity system.

FIG. 1B is a block diagram of an exemplary content interactivity system for streamed content.

FIG. 2 is a flow diagram of an exemplary content interactivity process.

FIG. 3 is a flow diagram of an exemplary content auction process.

FIGS. 4A and 4B are screenshots illustrating exemplary user interface elements for connecting to a gateway.

FIG. 4C is a flow diagram of an exemplary method of interacting with a gateway by way of a host device.

FIG. 5A is a block diagram of an exemplary gateway architecture.

FIG. 5B is a flow diagram of an exemplary method of operating a content interactivity gateway.

FIG. 6 is a block diagram of an exemplary host device architecture.

FIG. 7 is a block diagram of an exemplary peer-to-peer network including a resource gateway.

### DETAILED DESCRIPTION

### Content Interactivity System Overview

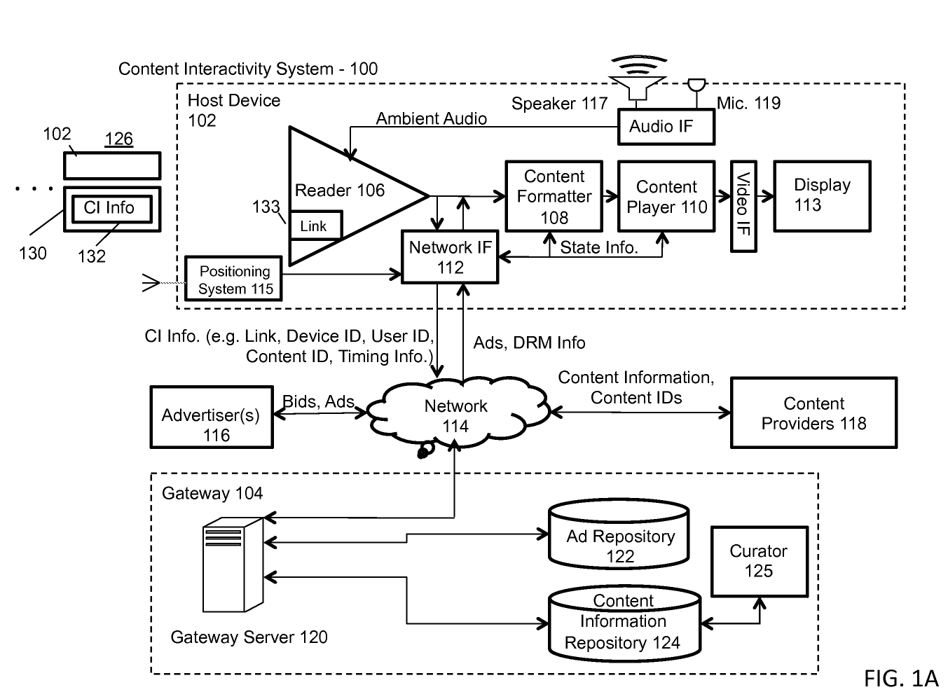

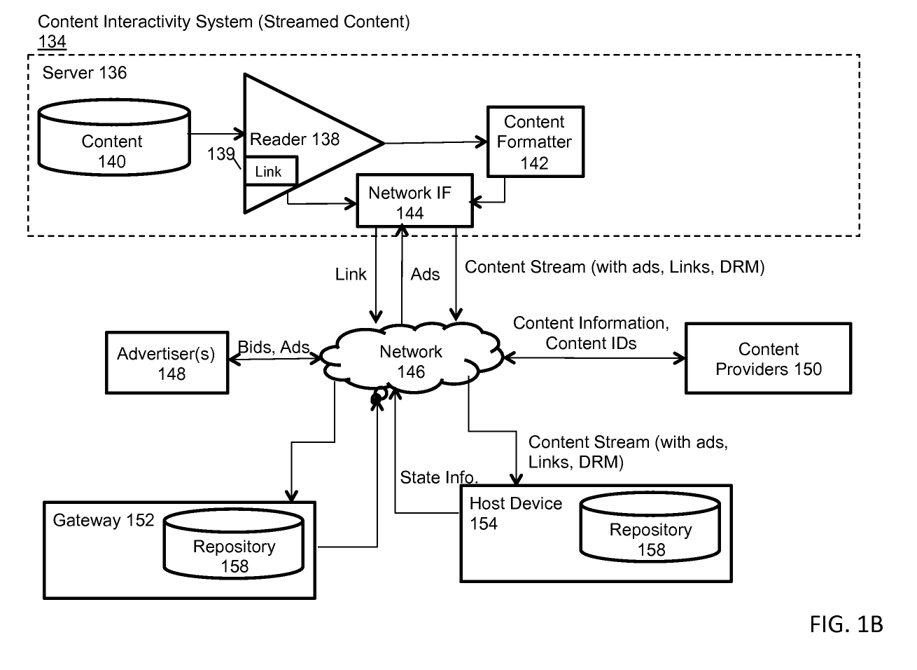

FIG. 1A is a block diagram of a content interactivity system 100. In some implementations, the system 100 includes one or more host devices 102 coupled to a resource gateway 104 through a network 114. One or more advertisers 116 and content providers 118 may use the network 114 to communicate with the gateway 104.

The host device 102 may be any device capable of receiving content, including but not limited to: computers, web-enabled devices, mobile phones, media players, music players, game consoles, personal digital assistants (PDAs), televisions, etc. Host devices 102 may also be devices tethered to devices coupled to the network 114 (e.g., removable storage devices).

The host device 102 may receive content from a “controlled” distribution channel or an “uncontrolled” distribution channel. A “controlled” distribution channel may be a channel in which content is distributed under control of a content owner or licensee. Such content may be monetized and distributed in accordance with DRM rules or procedures. By contrast, an “uncontrolled” distribution channel may be channel in which content is distributed outside the control of the content owner or licensee. Such content may typically not be monetized or may have been “pirated”. One example of an “uncontrolled” distribution channel is a peer-to-peer (“P2P”) network, where users may retrieve copies of copyrighted content from other user's host devices. Another example is the uncontrolled distribution of copyrighted content on a non-network medium (e.g., DVD, CD ROM, USB Drive, etc.).

The network 114 may be one or more communication channels configured in accordance with a variety of topographies. Some examples of a network 114 include but are not limited to: the Internet, an intranet, a peer-to-peer network, Ethernet, a Wide Area Network (WAN), Local Area Network (LAN), a wireless network, a cable television network, etc.

In some implementations, the gateway 104 may include the server 120, the advertisement (ad) repository 122, and the content information repository 124. The ad repository 122 may store ads and other related information. Ads may include, but are not limited to: banners, links, buttons, icons, frames, images, video, graphics, linked units, leader board, ticker tape, skyscrapers, referral buttons, themed units (e.g., related to holidays), audio snippets, etc. The content information repository 124 may include various content-related information, including DRM information (e.g., usage rights).

In the example shown, the repositories 122 and 124 are separate storage devices. In other implementations, the repositories 122 and 124 may be a single storage device, or multiple storage devices distributed over a network (e.g., a storage area network (SAN)). The gateway 104 may also include one or more servers 120, which are co-located in the same facility or distributed over a network.

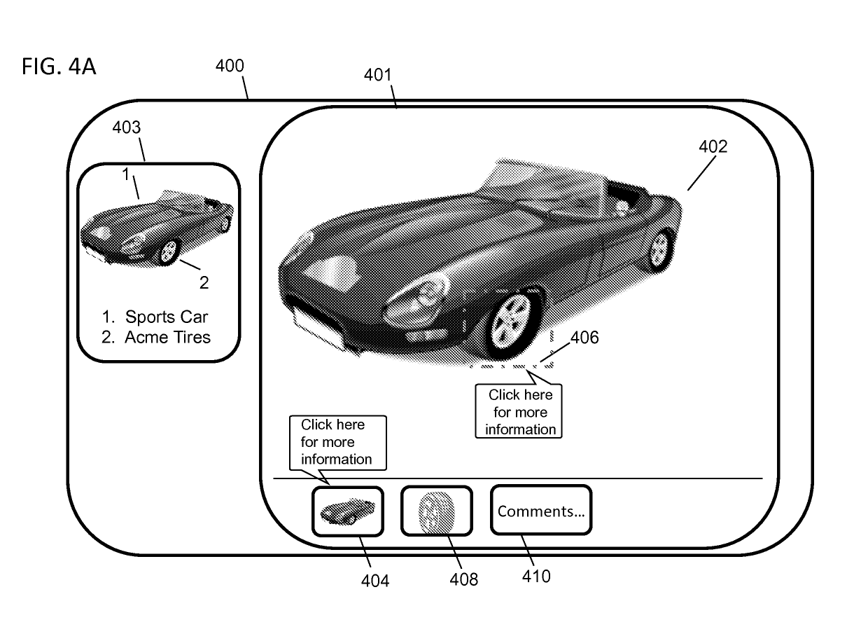

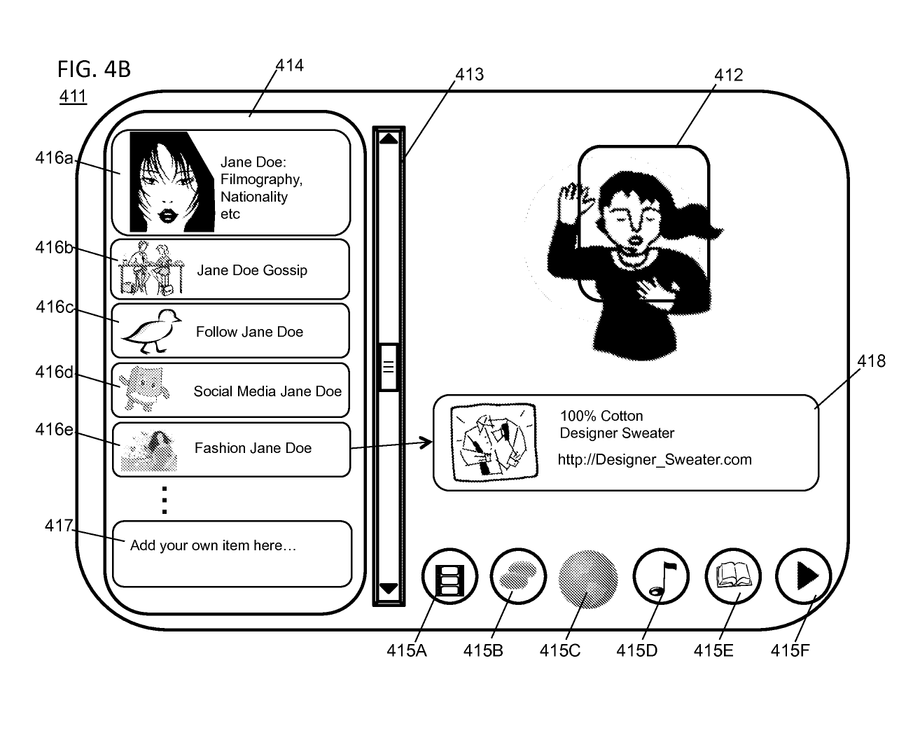

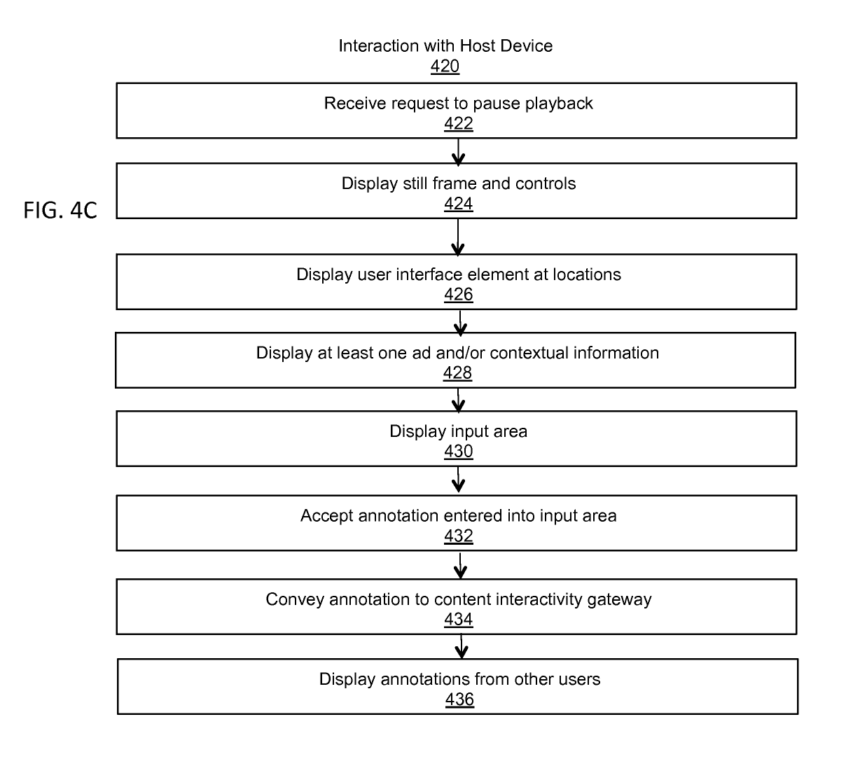

In an implementation that will be discussed with reference to FIGS. 4A-4C, the gateway 104 may include a curator function 125 in which annotations prepared and transmitted by users by way of a user interface element displayed on the host device 102 may be stored in the content information repository 125. As discussed hereinafter, the host device 102 may display and input area within which a user may enter annotations relevant to a portion of the content. The user's annotations, along with the annotations from other users may be stored within the content information repository 124. In an implementation, the curator 125 may review the annotations so that inaccurate or inappropriate annotations may be amended or deleted. Accordingly, other users of the host device 102 may have an opportunity to review and investigate the comments of perhaps dozens, hundreds, or even thousands of users viewing the same content.

In some implementations, the host device 102 may include a multi-protocol reader 106, a content formatter 108, and a content player 110. The reader 106 may be configured to extract content interactivity information (hereinafter also referred to as “CI information”) from the content 126 that may be used to establish a connection with the gateway 104, and to facilitate interactivity with various resources by, or through, the gateway 104. Some CI information may be included in the multi-protocol reader 106, such as a link 133 (e.g., URI) to the gateway 104. The content 126 may be any material which is of interest to users, including but not limited to: video, audio, text information, graphics, ads, digital photos, digital rights information, music, movies, software, multimedia, documents, television or radio broadcasts, web casts, web pages, etc.

In the example shown, the content 126 received by the host device 102 includes video content 128 and audio content 130. The audio content 130 and perhaps video content 128 may include CI information 132. The CI information 132 may include a link (e.g., Uniform Resource Identifier (URI)) and one or more identifiers. In some implementations, the CI information 132 may be retrieved from the payload of a digital watermark by the multi-protocol reader 106 (e.g., audio or video watermarks) and used to access various resources provided by, or through, the gateway 104. Generally, a digital watermark may include information that may be imperceptibly and robustly embedded in the content 126, such that the information cannot be removed. A digital watermark may typically include a payload that contains information about the origin, status, or recipient of the content 126. The payload may include other types of information, such as information describing the content 126 and links to resources. A watermark payload capable of carrying a URI for accessing a web site is described in U.S. Pat. No. 6,411,725, for “Watermark Enabled Video Objects,” which patent is incorporated by reference herein in its entirety. Various types of known audio and video watermarking techniques are suitable for use with the content interactivity system 100. Some of these watermarking techniques are described in Jeng-Shyang Pan, Hsiang-Cheh Huang, L. C. Jain, “Intelligent Watermarking Techniques (Series on Innovative Intelligence—Vol. 7),” World Scientific Publishing Company (2004), which is incorporated by reference herein in its entirety.

In other implementations, the CI information may be metadata, such as standardized content descriptors or XML descriptors which may be read by the multi-protocol reader 106 and distributed to host device 102 through various distribution channels, including over a network (e.g., the Internet, peer-to-peer, wireless) or through a storage media (e.g., a DVD, CD ROM, Flash drive).

In some implementations, the CI information 132 is persistent data (i.e., persists in the content 126) that is received with the content 126 at the host device 102. The CI information 132 may be combined with content 126 in different ways, including embedding the CI information 132 in the content 126 (e.g., in a digital watermark) or inserting the CI information 132 in the header or payload of a data packet or data stream. The CI information 132 need not be related to any specific resource (e.g., an advertiser website). Rather, resources may be matched to the content 126 by the gateway 104 based on information provided by advertisers 116 and content providers 118.

Using the gateway 104 to match content with resources provides advantages over conventional solutions that include dedicated links to predefined resources. With conventional solutions, the content providers 118 would have to manage a large number of dedicated links to individual resources, rather than a single “generic” link to the gateway 104. Using the gateway 104, the content providers 118 need only insert a single link in the content or the multi-protocol reader 106 (e.g., link 133) for connecting to the gateway 104 and a content identifier for identifying the content, and the gateway 104 handles the rest, by matching resources (e.g., ads, DRM information) with content based on the content identifier and other information collected from advertisers 116 and content providers 118 or the host device 102 (e.g., host device ID, user ID, location information).

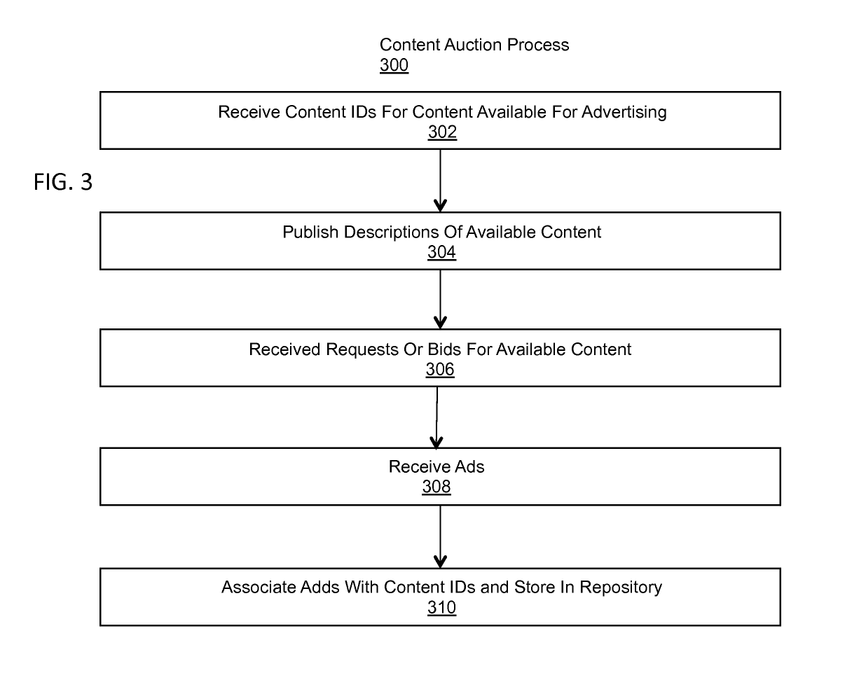

In some implementations, the CI information 132 is read by the multi-protocol reader 106 and transmitted to the gateway 104, where the information is used to match the content 126 with one or more resources, such as ads from one or more advertisers who previously bid on ad space associated with the content 126, as described in reference to FIG. 3. In addition to a link for connecting to the gateway 104, other CI information 132 may be received with the content 126, including but not limited to: a content identifier, a user identifier, a host device identifier, timing information for enabling the gateway 104 to determine the portion of content 126 that is currently playing on the host device 102, the geographic location of the host device 102, personalized information related to the user of the host device 102, etc.

In some implementations, all or a portion of the CI information 132 may be contained in digital watermarks, headers, or metadata, which may be associated with the content 126. If digital watermarks are used to carry the CI information 132, then the reader 106 may be configured to read the watermarks and decode the CI information. The digital watermark may be fully or partially decoded by the reader 106. For example, the reader 106 may be a secure binary audio watermark reader, which implements standard audio codec technology (e.g., AAC, HE-AAC) to provide partially decoded content (e.g., filter bank outputs) to the gateway 104, which then performs or completes the watermark extraction, so that the CI information 132 may be retrieved. The reader 106 may also be a secure binary video or image watermark reader, which sends partially decoded content to the gateway 104 for decoding of the video or image watermark.

In other implementations, all or a portion of the CI information 132 may be stored locally in the host device 102 (e.g., Flash memory, hard disk) or an external storage device (e.g., network device, removable storage device) operatively coupled to the host device 102. When the gateway 104 is contacted, the gateway 104 may use the CI information 132 to access a variety of informational, advertising and merchandising resources provided by, or through, the gateway 104. Other preprocessing may also be performed by the reader 106.

In some implementations, the CI information 132 may be included in the content player 110. Examples of content players include but are not limited to software media players, such as Microsoft Inc.'s Windows™. Media Player and RealNetworks, Inc.'s RealPlayer™.

In some implementations, the content 126 received by the host device 102 may be protected using one or more known techniques (e.g., scrambling, encryption, steganographic concealing of critical information), which requires reformatting (e.g., reconstruction) of the content 126 by the content formatter 108 using information contained in an audio, image or video watermark, as described in U.S. Provisional Patent Application No. 60/739,812, for “Content Protection Through The Use of Watermarking,” which provisional application is incorporated by reference herein in its entirety. Once the content 126 is reconstructed, the content 126 may be output to audio or video interfaces (or both) for playing the content on the host device 102 using a display screen 113, speaker system 117 or headphones (or both).

In some implementations, a one-time pad encryption key or “pad” may be inserted in a watermark to address key management issues. Each instance of content may be individually encrypted with its own key/pad. A look-up table (LUT) or mapping algorithm (pad) contained in the watermark may be used to map a standard Hex sequence to a one-time random Hex sequence. For example, the standard hex sequence 1, 2, 3, . . . , D, E, F, may be mapped to a one-time random Hex sequence 4, 8, F, . . . 0, 2, 5, A. Since the key or pad travels with the content there are no key management issues.

In some implementations, ambient audio transmitted by, for example, the speakers may be received through an audio detection device (e.g., a microphone 119). The ambient audio may include CI information 132 that may be extracted and transmitted to the gateway 104, where the CI information may be used to connect to the gateway 104 and to provide access to a variety of information, advertising and merchandising resources.

CI information 132 may be added to content 126 by content owners or by third parties in a distribution chain (e.g., a broadcaster, clearing house). A link to the gateway 104 may be inserted in the payload of a digital watermark embedded in, or transmitted with, the content 126. Alternatively, the link to the gateway 104 may be included in the multi-protocol reader 106, which may be distributed to host devices 102, and automatically installed on the host devices 102 using standard operating system installation methods. For example, compressed code for the multi-protocol reader 106 containing a hard coded link to gateway 104 may be transmitted in the beginning of a content bit stream and automatically unpacked, uncompressed (if compressed) and installed while the content is being buffered in preparation for playback on the host device 102. There are many possible manifestations of the multi-protocol reader 106 that may be distributed to host devices 102. For example, the reader may be distributed as part of: 1) independent executable software, 2) an operating system or operating system component (e.g., plug-in, dynamic link library), 3) DRM software or hardware, 4) encryption/decryption software or hardware, 5) compression or decompression software or hardware, and 6) digital signal processing (DSP) software or hardware. The reader may be inserted anywhere in audio or video processing paths in a host device 102, including during decryption, decompression or presentation processes.

In some implementations, state information may be generated by the content player 110 and sent to the gateway 104 through the network interface 112 and network 114. Examples of state information includes content player states, such as start, stop, pause, fast forward, reverse, slow motion, shuffle, etc. The gateway 104 may use the state information to determine how to deliver ads. For example, while the state of the content player 110 is in “fast forward,” the gateway 104 may stop delivery of ads, since the user would not be able to interact with the ads in a meaningful way.

In some implementations, information may be generated by a positioning system 115 (e.g., GPS). For example, a GPS receiver may be included in the host device 102, which supplies location information to the gateway 104, which may be used to connect the user's location to appropriate informational, advertising and merchandising resources. Alternately, geo-positioning services which keep databases of the geographic location of IP address may be used to supply location information to the gateway 104. Alternately a trace-route may be used to identify the IP addresses of the various servers and nodes used in the delivery of content. Those skilled in the art will recognize that through the use of a trace-route and geo-positioning services which keep databases of the location of IP address the geographic location of the user may be determined with greater certainty. This information may be used to supply location information to the gateway 104 even if the user is attempting to obfuscate their location through IP spoofing or other techniques. In some implementations, this location information may be used to deliver location based ads or services.

In some implementations, the gateway 104 may include a website that provides user interfaces for advertisers 116 and content providers 118. In such a configuration, the gateway 104 may function as a content aggregator or ad syndicate. Additionally, the gateway 104 may act as repository or manager of DRM for content providers 118. In some implementations, the advertisers 116 and content providers 118 may login to the gateway 104 and set-up an account. A subscription fee or other compensation may be paid by the advertisers 116 or content providers 118 for various services provided by, or through, the gateway 104.

In some implementations, the gateway 104 may be configured to receive content descriptions and content identifiers for content that is available for receiving ads. The gateway 104 may use the content descriptions to match content with the needs of advertisers or publishers who wish to include ads in the content. Content identifiers may be embedded in the content 126 at specific locations associated with the advertised product(s) or service(s). In the example shown, the reader 106 may extract a content identifier from the CI information 132 and sends the content identifier to the gateway 104. The gateway server 120 receives the content identifier and matches the identifier with ad(s) associated with the identifier. The ads may be downloaded by the server 120 to the host device 102 where the ads may be embedded in, or overlaid on, the content 126 by the content formatter 108 at specified locations. The ads may be presented on a frame, strip, side bar or other display area proximate to the content 126. The ads may also be presented during a pause in the consumption (e.g., viewing of a film) of the content 126. To thwart piracy, moving or static ads may be embedded in, or overlaid on, a strip or subsection of the content 126, so as to partially or fully obfuscate the content. The ads may invite the user to contact the gateway 104 or the content providers 118 directly to receive an authorized version of the content 126. Once authorized, the ads may be removed from the content 126 and replaced with the original content displaced by the advertisement.

In some implementations, the gateway 104 may send DRM commands and other DRM information to the host device 102, which may control the reconstruction of content. For example, a DRM command may be used by the content formatter 108 to disable or otherwise cause the content 126 to remain scrambled, encrypted, or to be displayed with low resolution, artifacts, warning messages, etc. DRM commands may also be used by the content player 110 to stop, pause or otherwise disrupt the playing of the content 126 on the host device 102.

In some implementations, content timing information or position information may be provided to the gateway server 120 by the host device 102. The timing information may enable the server 120 to present ads to the user of the host device 102 at the right moment as an icon, link or other user interface element, which may be activated by a user to display the advertisement. The server 120 may assign different ads to different parts of the content as agreed to by the advertisers 116 and content providers 118. The coordinates for ad space within a display screen may be provided by the content providers 118 and adjusted by the gateway 104 based on host device information. For example, the content providers 118 could provide information about ad space available with the content 126, such as the sequence of video frames that include the available ad space, where the ad space is located in the frames (e.g., video frame coordinates), the types of ads allowed in the ad space, whether the ads may be static, dynamic or interactive, the length of the video sequence for which the ad space will be presented, etc. Using information about the display screen 113 of the host device 102 (e.g., size, resolution, color palette), the gateway 104 may format the ads for display on the host device 102. Such information could be stored in a database at the gateway 104, and accessed using a host device identifier. Content owners may wish to leave blank certain sections of a video (e.g., a billboard appearing in a film) which may then be overwritten by an advertisement. This is already practiced in television by the use of a technique known as “blue screening.”

In some implementations, the CI downloaded with or in the content may be detected or decoded by a Java™ applet or servlet associated with the user's browser and which will act as a partial or full implementation of the multi-protocol reader. In such an event, all or some of the functions of the multi-protocol reader may be implemented without installing client software on the host device.

### Content Interactivity System for Streamed Content

FIG. 1B is a block diagram of an exemplary content interactivity system 134 for streamed content. The system 134 includes a content server 136 coupled to a resource gateway 152 and a host device 154 through a network 146 (e.g., the Internet, wireless network). Other configurations are possible, including but not limited to multiple content servers, host devices and resource gateways.

In some implementations, the content server 136 includes various components (e.g., servers) for streaming content to multiple host devices 154, together with other information obtained from the gateway 152. The server 136 includes a multi-protocol reader 138, a content formatter 142, a network interface 144 and a content repository 140. The reader 138 reads content from the repository 140 or other content resource, and extracts CI information (e.g., content ID, timing information), which may be sent to the gateway 152 through the network interface 144. A communication channel or link may be established between the reader 138 and the gateway 152 using a link 139 (e.g., a URI) contained in the reader 138 or extracted from the content. If the content is protected (e.g., scrambled content), a watermark or other information contained in the content may be extracted and used by the content formatter 142 to re-construct the content before streaming the content to the host device 154.

In some implementations, the protected content is sent to the host device 154 and the host device 154 re-constructs the content. In other implementations, partially re-constructed content is sent to the host device 154, and the host device 154 completes the re-construction.

The host device 154 may include a content player 156 for playing content. Some examples of content players are Windows™ Media Player developed by Microsoft™ Corporation and QuickTime™ developed by Apple Computer, Inc. The host device 154 may be any device capable of receiving content, including but not limited to: computers, web-enabled devices, mobile phones, media players, music players, game consoles, personal digital assistants (PDAs), televisions, etc. The host device 154 may also be devices tethered to devices coupled to the network 146 (e.g., removable storage devices). In some implementations, the host device 152 may log into a website, or other interface associated with the server 136, and request the streaming of content (e.g., video, audio). The streamed content is received by the host device 154 through the network 146 using known streaming protocols (e.g., UDP, RSTP, HTTP). The content player 156 on the host device 154 may present the streamed content to the user of the host device 154.

The resource gateway 152 may include a repository 158 for storing ads, links and other information (collectively, referred to as “resources”). In addition to the repository 158, the gateway 152 may include various components (not shown) for communicating with the content streaming server 136, such as one or more server computers, etc. The reader 138 in the server 136 establishes communication with the gateway 152 and passes CI information to the gateway 152 that may be used to determine resources associated with the content. For example, a content ID and timing information may be sent to the gateway 152, where one or more of the content ID and the timing information may be used to select an ad that may be provided to the host device 154 with the streamed content.

### Content Interactivity Process

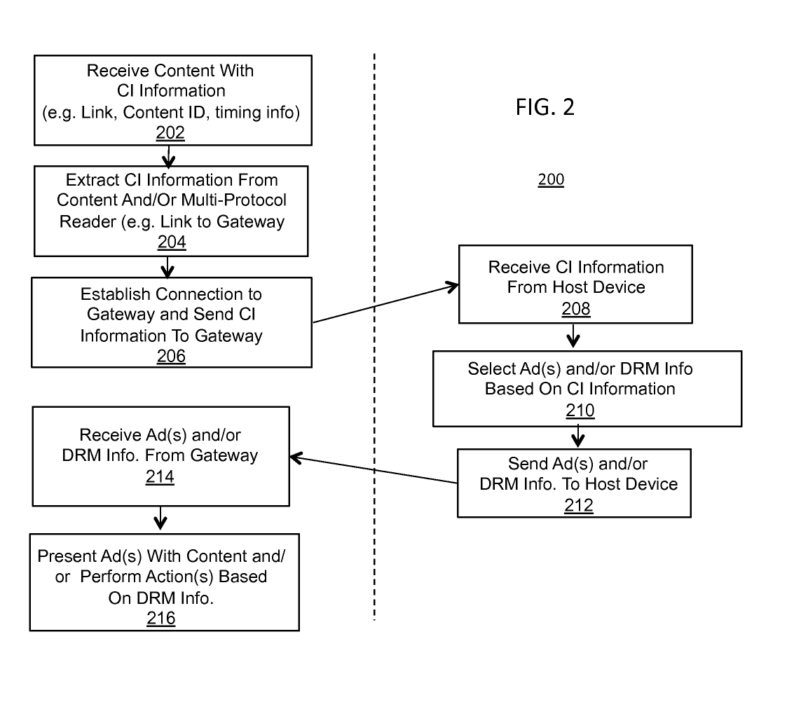

FIG. 2 is a flow diagram of an exemplary content interactivity process 200. The process 200 may include interactivity between a host device and a gateway over a network. Multiple instances of the process 200 may occur concurrently between a single host device and a single gateway, between multiple host devices and a single gateway, between a single device and multiple gateways or between multiple devices and multiple gateways. Gateways may be localized to a particular geographic region or location. Communications between host devices and gateways may occur over a variety of communication mediums (e.g., copper, optical fiber, radio frequency waves) using a variety of known communication protocols (e.g., TCP/IP, ISDN, POTS).

In some implementations, the process 200 begins when a host device receives content that includes CI information (202). CI information may have particular relevance to the entire content or separate CI information may be relevant to different portions of the content. CI information may be inserted at specified locations in the content (e.g., specified frames) or provided at the beginning or end of a stream of content. The CI information may be multiplexed with the content at a different frame rate than the content. In some implementations, when the content is received at the host device, a multi-protocol reader reads or otherwise extracts the CI information from the content (204) using known techniques. In some implementations, at least some CI information is included in the multi-protocol reader, which may be distributed with content or otherwise installed on the host device using other means (e.g., pre-installed on the host device, downloaded from website, installed from storage media). The CI information included in the multi-protocol reader may be a link (e.g., a URI), which may be used to establish a connection to the gateway, for providing access to a variety of informational, advertising and transactional resources. In some implementations, the CI information may include a content identifier, host device identifier or user identifier for matching the content, host device or user with ads, DRM information or other information and services (e.g., online stores, social networks, chat rooms, advertiser websites, payment websites (e.g., PayPal™), etc.

The host device establishes a link with the gateway (e.g., using the link included in the multi-protocol reader) and sends all or some of the CI information to the gateway (206), where it is received by the gateway (208) and processed. In some implementations, the CI information may be used to select ad(s) or DRM information (210) at the gateway. Examples of DRM information include but are not limited to: commands, warning messages, instructions for acquiring a license or authorization, copyright information, etc.

The gateway sends the ad(s) perhaps accompanied by DRM information to the host device (212), which receives the ad(s) or DRM information (214). The host device presents the ad(s) or DRM information on a display screen or an audio system of a host device (FIG. 1), or otherwise acts upon the information depending on the application (216) (e.g., execute DRM commands). For example, ads may be placed in ad space that is embedded in, overlaid on, or displayed proximate to content. If the gateway sends DRM information to the host device, which includes DRM commands, the DRM commands may be executed by a DRM client process in the host device (e.g., disabling reconstruction of the content, decrypting content). If the DRM information includes a warning message regarding pirating or instructions for obtaining a license, such messages may be displayed or otherwise presented on the host device while the content is playing.

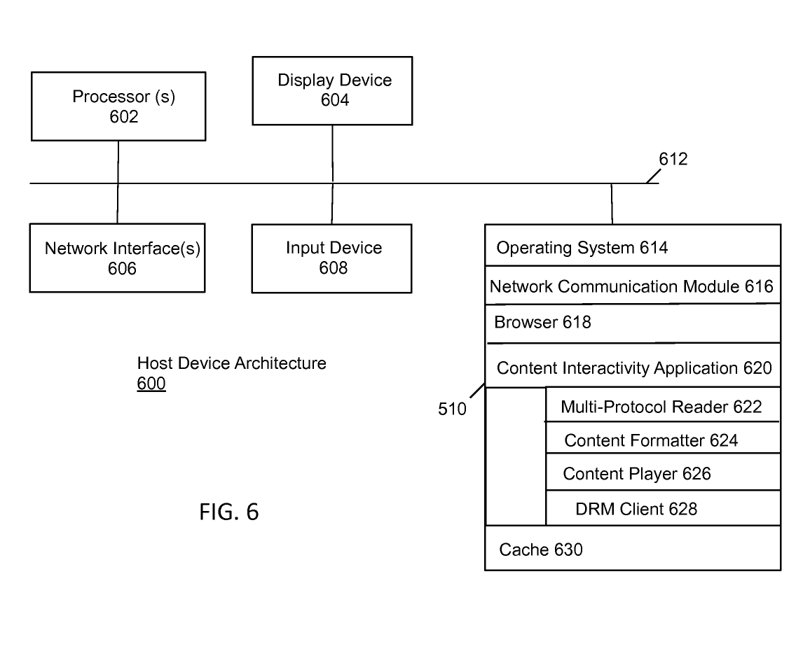

In some implementations, ads and perhaps other information may be stored in cache 630 of the host device (See FIG. 6). For example, the reader 106 may detect when the host device from disconnected to the network 114 and retrieve static ads, links or other information from the cache 630, rather than receiving such items directly from the gateway 104. When the host device 102 is reconnected to the network 104, the contents in the cache 630 may be updated by the gateway 104. The updating may be performed on a scheduled basis or in response to a trigger event.

In some implementations, the cache 630 may be continuously or periodically updated with ads or other information while the host device 102 is online. Such updating may be performed as a background process that is transparent to the user. To reduce latency, the reader 106 may be configured to access the cache 630 for ads, links or other information, rather than receiving the ads, links or other information directly from the gateway 104.

### Content Auction Process

FIG. 3 is a flow diagram of an exemplary content auction process 300. In some implementations, a gateway provides means for matching content available for advertising. To facilitate the process 300, the gateway may include a website that provides user interfaces for advertisers and content providers. Content providers may establish accounts with, or through, the gateway and submit content descriptions, content identifiers and other information for content they wish to make available to advertisers. Similarly, advertisers may establish accounts and submit ads, bids and other information for a content auction managed by the gateway. In some implementations, a user interface may be provided for third parties who append additional content descriptors or watermarks to content owned or controlled by others (e.g., authorized distributors.

The process 300 begins when the gateway receives content descriptions and content identifiers for the content to be made available to advertisers (302). The gateway publishes or otherwise makes available a process for advertisers to select or bid on the available content (304). The publication may occur through a website, broadcasts, emails or any other communication medium. The gateway receives requests or bids from advertisers for available content (306). The gateway receives ads for placement with content (308).

In some implementations, the advertisers may specify how and where the ads will be placed within the content. Content may be pre-screened and as a result, sections of it may be pre-identified with keywords, such as “car”, “boat” etc., or with the brand names of products appearing in the content. Advertisers may pick which sections of content are the most relevant to their products, similarly to the way online advertising may be associated with keywords. The advertisers may also provide the gateway with different types of ads for placement in content (e.g., banners, buttons). The gateway associates the ads with content identifiers and stores the ads and content identifiers in a repository (310). For example, the ads and content identifiers may be stored in a database (e.g., MYSQL™), directory (e.g., LDAP directory), file system, table or any other suitable data structure, which may be indexed or otherwise accessed by the gateway.

In some implementations, content may be divided into time sectors, of equal or different lengths. Each time sector may be assigned to one or more key words, brand names or other information. Ads may be assigned to the keywords, brand names or other information and priced based on a variety of factors. Pricing factors include but are not limited to: 1) the desirability of the content (e.g., name recognition, date of release), 2) the length of the time sector during which a keyword persists, 3) availability of an ad for off-line interaction (e.g., a cached ad), and 4) geographic location for which the ad is targeted. Other pricing factors are also possible.

### User Interface Elements

FIG. 4A is a screenshot illustrating exemplary user interface elements for connecting to a gateway. In the example shown, a user interface 400 includes a display 401 (e.g., a browser window, media player display) for presenting content 402 (e.g., a video) and an optional side bar 403 for displaying information related to the content (e.g., ads, links). The user interface elements 404 and 406 provided by a gateway have been added to the display 401. In this example, the content 402 is an automobile (and its tires), the user interface elements 404, 408, are icons and the user interface element 406 is a box. Other user interface elements are possible, such as links or controls represented as icons at the top, bottom or sides of the display screen, as outlines or boxes around video objects, which are associated with informational, advertising and merchandising resources, or icons appearing at the end of the content. Video objects may be associated with multiple user interface elements. For example, the tires may be associated with the bounding box 406 and the icon 408.

In an implementation, the user input area 410 enables a user to enter comments or annotations relevant to the user interface element 406. In an exemplary implementation, a user may have personal experience with a product or type of products identified within the user element 406 and may wish to contribute these comments or annotations to other viewers of the same content. These annotations may include where a product may be purchased, if a discount is available, and a price of the product. In addition, the user may wish to review comments posted by other users. In this manner, a knowledge base that includes user's annotations, which may include experiences, comments, reviews, and so forth, may grow over time.

While the content 402 is playing on a host device, one or more watermarks may be read and one or more content identifiers associated with the car and its tires may be sent to a gateway. Ads for the automobile and its tires are matched with the content identifiers and may be sent to the host device where the ads, or links to the ads, may be displayed as shown in FIG. 4A. In some implementations, links to the ads may be displayed in the content 402 when the playing of the content is paused. Alternatively, the ads or links may be displayed in the sidebar 403, or other display in the user interface 401, while the content is playing. In the example shown, the side bar 403 presents a thumbnail image of products shown in the content 402 (e.g., a car and tires) and the links for the products identified.

In some implementations, a timer may be started at the host device for which an ad should be presented to the user. If a threshold time is exceeded, then the placement of the ad may be skipped. If the content is video, the placement of the ads may be across a predetermined number of video frames, or for a predetermined period of time (e.g., the length of a movie scene). Audio may be provided with the ads (e.g., streamed or downloaded with the ads), which describes the ad targeted content or provides other information related to the targeted content (e.g., instructions for using the icon 404 or box 406). In some implementations, multiple objects in a frame, frame sequence, scene or other portion of content may be separately targeted with ads. In the example shown, the automobile and the tires are separately targeted with the icon 404 and the box 406, respectively. The user may interact with the icon 404 by clicking on the icon 404 with a pointing device or mousing over the icon 404. When the user interacts with the icon 404 or the box 406 a bubble or other display may be presented, providing instructions or other information related to the targeted video object.

In some implementations, all or some of the links associated with content may be aggregated and presented in a list or other display at the end of the content playback. For example, when the content playback is stopped (e.g., by the user or automatically when the content is exhausted), then some or all of the links or ads associated with the content may be presented to the user in a list or other display. Such links may remain active in the side bar 403 for a predetermined period of time after the content is terminated (e.g., an hour), or may remain active until the occurrence of a predetermined trigger event (e.g., playback of different content, content player is closed, host device is powered-off).

In some implementations, trailers in the beginning of video content may be completely replaced, so that each time the content is viewed, up-to-date trailers are presented to the user (e.g., movies that have not yet been released). Since trailer are typically part of the content, the content formatter 108 or the reader 106 may include a rendering engine for rendering ads, links and other information that may be used to replace content. In some implementations, a separate rendering engine may be used to render ads, links and/other information.

FIG. 4B (411) is a screenshot illustrating example user interface elements for connecting and providing interactive content to a gateway. Contextually related information may be displayed to the user by way of additional icons in a manner that creates a feature-rich informational resource. In FIG. 4B, an actress 412 is shown within a user interface element while the user has paused the scene. In an implementation, the user interface element corresponding to the actress 412 may slaunch a stack 414 which may include numerous icons, such as the icons 416a, 416b, 416c, 416d, and 416e, in which the icons are stacked atop one another.

Further, in an implementation, the icons 416a through 416e, 417, and 418 are displayed only during a pause of the scene. As will be discussed later herein, a user input area, such as the input area displayed within the icon 417, may also be displayed in which users may enter annotations pertaining to the actress 412.

In one example, the icon 416a (Jane Doe: Filmography, nationality, etc.)

may provide a user with filmography, birthplace and/or nationality, interests, and other material of interest to fans of the actress 412. In another example, the icon 416b (“Jane Doe Gossip”) may provide an input area, or a link to an input area, that may enable a user to view articles, blogs, and other materials concerning the actress 412. In another example, the icon 416c (“Follow Jane Doe”) may provide an input area, or a link to an input area that may enable a user to receive periodic and/or occasional updates concerning the whereabouts and recent events involving the actress 412. In another example, the icon 416d (“Social Media Jane Doe”) may enable a user to connect with one or more fan pages at a social media website. In another example, the icon 416e (“Fashion Jane Doe”) may provide a user with an icon or a link to an icon, such as the icon 418, that includes purchase and sale information concerning one or more articles worn by actress 412 in a scene. However, it should be noted that these are just a few of numerous examples of contextual information relevant to actress 412 and/or one or more scenes, and claimed subject matter is not limited in this respect.

In the example of FIG. 4B, any number of icons may be added by the user by way of user the input area 417. In implementation, a user may supply additional annotations to provide additional context to one or more particular scenes of the movie. In an example, a user may recognize contextual information such as an article of clothing, vehicle, background, or anything else related to an item in the scene. In an example, a user may enter contextual information pertaining to the new item, such as, commentary pertaining to the designer sweater shown in the scene, the shoes worn by the actress, or commentary related to any other item in the scene. By way of the user input area 417, the knowledge base related to the actress 412, a movie or scene featuring the actress 412, may continue to grow over time as additional users enter descriptions and annotations into user the user input area 417. In an implementation, the scrollbar 413 may be used to scroll through the stack 414 and through numerous additional icons added by various users until reaching the user input area 417.

Also present in FIG. 4B is the chat control 415B. In an embodiment, selecting the chat control 415B, may result, for example, in the opening of a chat window, which may allow two or more users to interact to perhaps discuss various aspects of a scene of the movie, or items present within a scene of the movie. Also present in FIG. 4B is the location control 415C, which, upon a user selecting the control 415C, may result in a display of information concerning locations at which a scene of the movie was filmed. This information may include tourist information, history, current event, and so forth, and claimed subject matter is not limited in this respect.

Also present in FIG. 4B is the soundtrack control 415D. In an embodiment, selecting the soundtrack control 415D may direct a user to a website at which the soundtrack or other contextual information concerning music from the movie may be purchased. Also present in FIG. 4B is the bookmark control 415E. In an embodiment, selecting the bookmark control 415E may result in the host device 102 (of FIG. 1) locally storing one or more bookmarks in a memory so that a user may easily return to a bookmarked scene.

FIG. 4C is a flow diagram of an exemplary method of interacting with a gateway by way of a host device. The process 400 begins with a playback device (such as the host device 102) receiving the request to pause the playback of video content (422). When the host device has pause playback, a layer that includes controls is displayed over the still frame (424). A user interface element may then be displayed (426). In an implementation, the interface element may be relocated under the control of the user to particular locations (hotspots) within the displayed still frame. When the user interface element has been located at particular locations, such as over the bounding box 406 of FIG. 4A, one or more icons (such as the icons 404 and 408) may be displayed. In an implementation, the icons 404 and 408 represent advertisements (428), which may correspond to an automobile or perhaps an accessory (such as a tire) installed on the automobile. In another implementation, icons 404 and 408 represent contextual information such as commentary pertaining where the movie was filmed, background on the actors and actresses in a scene, blogs pertaining to aspects of a scene, just to name a few examples, and claimed subject matter is not limited in this respect.

In addition to advertisements, the host device may additionally display and input area (430). In an implementation, a user may enter an annotation into the input area (432). The annotation may include a user's personal experience with a particular advertised product, such as an automobile tire as shown in FIG. 4, or any other comments that a user may feel are appropriate. These comments may then be conveyed to a content interactivity gateway (such as the gateway 104 of FIG. 1A. Additionally, appropriate comments, perhaps after a review by a moderator, may be available for other users to investigate or consider. Annotations from other users, perhaps appropriately screened by a curator of the content interactivity gateway may then be displayed to the user (436).

### Gateway Architecture Example

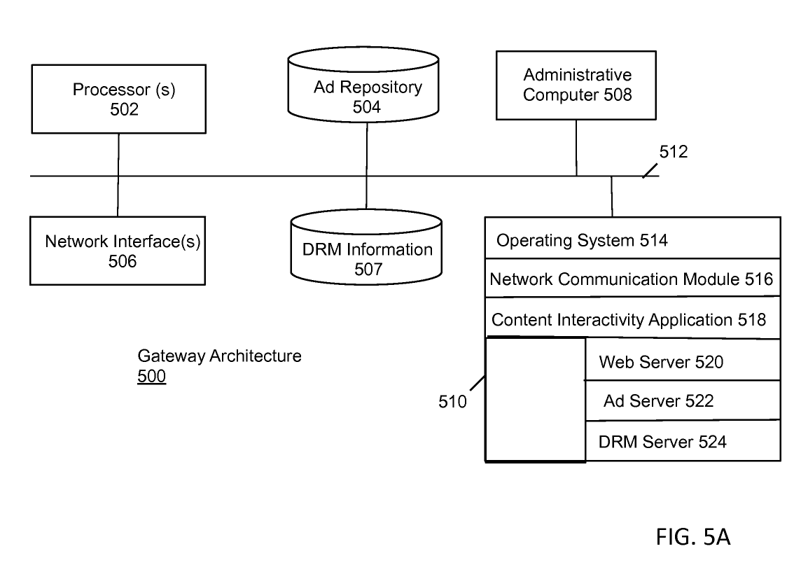

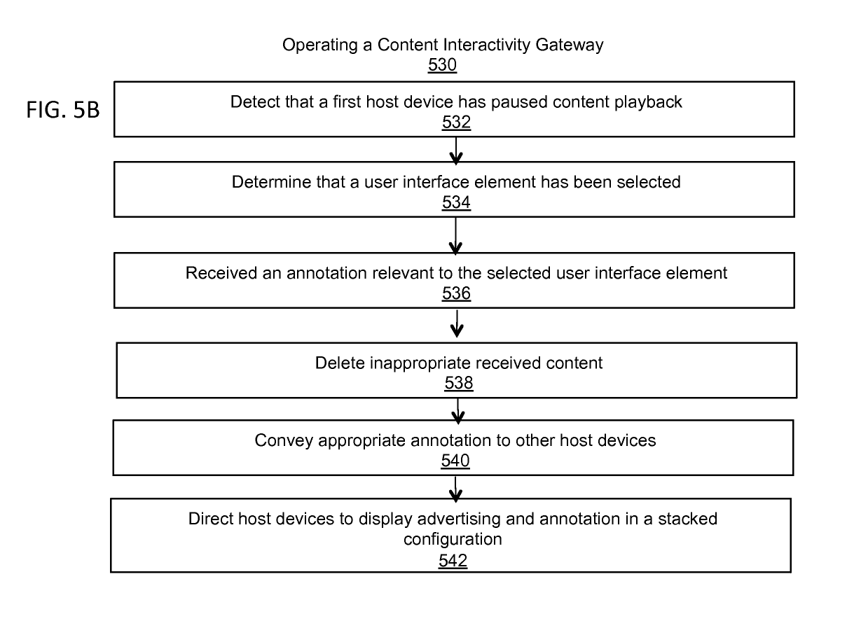

FIG. 5A is a block diagram of an exemplary gateway architecture 500. Other architectures are possible, including architectures with more or fewer components. In some implementations, the architecture 500 includes one or more processors 502 (e.g., dual-core Intel™ Xeon™ Processors), an ad repository 504, one or more network interfaces 506, a DRM repository 507, an optional administrative computer 508 and one or more computer-readable mediums 510 (e.g., RAM, ROM, SDRAM, hard disk, optical disk, flash memory, SAN, etc.). These components may exchange communications and data over one or more communication channels 512 (e.g., Ethernet, Enterprise Service Bus, PCI, PCI-Express, etc.), which may include various known network devices (e.g., routers, hubs, gateways, buses) and utilize software (e.g., middleware) for facilitating the transfer of data and control signals between devices.

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media may also take the form of acoustic, light or radio frequency waves.

The computer-readable medium 510 further includes an operating system 514 (e.g., Mac OS™ server, Windows™ NT server), a network communication module 516 and a content interactivity application 518. The operating system 514 may be multi-user, multiprocessing, multitasking, multithreading, real time, etc. The operating system 514 performs basic tasks, including but not limited to: recognizing input from and providing output to the administrator computer 508; keeping track and managing files and directories on computer-readable mediums 510 (e.g., memory or a storage device); controlling peripheral devices (e.g., repositories 504, 507); and managing traffic on the one or more communication channels 512. The network communications module 516 includes various components for establishing and maintaining network connections (e.g., software for implementing communication protocols, such as TCP/IP, HTTP, etc.).

The content interactivity application 518 includes a web server 520, an ad server 522 and a DRM server 524. These servers may be server processes running a single server (e.g., server 120) or run on separate servers or server processes co-located in the same facility or distributed over a network. The web server 520 may provide user interfaces in the form of web pages for advertisers and content providers to interact with the gateway, and may also serve web pages to host devices in response to user interaction with user interface elements. The ad server 522 manages processes related to ads and the transmission of ads to host devices. For example, the ad server 522 may host processes for matching content identifiers with ads, as described in reference to FIGS. 1-4. The DRM server 524 manages DRM processes, as described in reference to FIGS. 1-4.

The architecture 500 is one example of a suitable architecture for hosting an ad targeting application. Other architectures are possible, which include more or fewer components. For example, the ad repository 504 and DRM repository 507 may be the same storage device or separate storage devices. The components of architecture 500 may be located in the same facility or distributed among several facilities. The architecture 500 may be implemented in a parallel processing or peer-to-peer infrastructure or on a single device with one or more processors. The content interactivity application 518 may include multiple software components or may be comprised of a single body of code. Some or all of the functionality of the content interactivity application 518 may be provided as a service to content providers, advertisers and end users over a network. In such a case, these entities may need to install client applications. Some or all of the functionality of the ad targeting application 518 may be provided as part of a search engine and may use information gathered by the search engine to target ads, as described in reference to FIGS. 1-4.

FIG. 5B is a flow diagram of an exemplary method of operating a content interactivity gateway. The method begins with detecting that a first host device has paused content playback (532). The method continues with determining that a user interface element has been selected (534). In one implementation, a user interface element operates as a bounding box. The method continues receiving an annotation relative to the selected user interface element (536). Continuing, a curator function may be employed in which quality and appropriateness of a received annotation may be assessed. Following a curator function, inappropriate content may be deleted (538) and appropriate annotations conveyed to other hosts devices (540). The method concludes with directing additional host devices, such as those in use by other users, to display annotated information is stacked configuration. In an implementation, advertising is displayed along with contextual information pertaining to other users experiences, comments, and other materials that pertain, for example, to a particular scene, location, actor/actress, and so forth.

### Host Device Architecture Example

FIG. 6 is a block diagram of an exemplary host device architecture 600. Other architectures are possible, including architectures with more or fewer components. In some implementations, the host device architecture 600 includes one or more processors 602 (e.g., dual-core Intel™. Xeon™ Processors), a display device 604 (e.g., an LCD), a network interface 606 (e.g., a Ethernet, USB, Firewire™), one or more input devices 608 (e.g., mouse, keyboard) and one or more computer-readable mediums 610 (e.g., RAM, ROM, SDRAM, hard disk, optical disk, flash memory, SAN, etc.).

The components of the host device architecture 600 described above may exchange communications and data over one or more buses 612 (e.g., EISA/ISA, PCI, PCI-Express) for facilitating the transfer of data and control signals between the component of the architecture 600.

The term “computer-readable medium” refers to any medium that participates in providing instructions to a processor 602 for execution, including without limitation, non-volatile media (e.g., optical or magnetic disks), volatile media (e.g., memory) and transmission media. Transmission media includes, without limitation, coaxial cables, copper wire and fiber optics. Transmission media may also take the form of acoustic, light, or radio frequency waves.

The computer-readable medium 610 further includes an operating system 614 (e.g., Mac OS™, Windows™ XP, Linux^{T}. OS), a network communication module 616, a browser 618, and a client content interactivity application 620.

The operating system 614 may be multi-user, multiprocessing, multitasking, multithreading, real time, etc. The operating system 614 performs basic tasks, including but not limited to: recognizing input from the input devices 608 and providing output to the display device 604; keeping track and managing files and directories on computer-readable mediums 610 (e.g., memory or a storage device); controlling peripheral devices (e.g., printers, external storage devices); and managing traffic on the one or more buses 612. The network communications module 616 includes various components for establishing and maintaining network connections and services (e.g., software for implementing communication protocols and services, such as TCP/IP, HTTP, sync services, etc.).

The client content interactivity application 620 includes various software components (e.g., written in Java™, Objective-C or other known computer languages) for performing the client interactivity processes on a host device, as described in reference to FIGS. 1-4. These components include a watermark reader 622 for reading watermarks, a content formatter 624 for re-constructing content, a content player 626 for playing content and a DRM client for performing client-side DRM commands and tasks. The content interactivity application 620 may include multiple software components or it may be a single body of code.

### Content Interactivity Gateway For Peer-to-Peer Networks

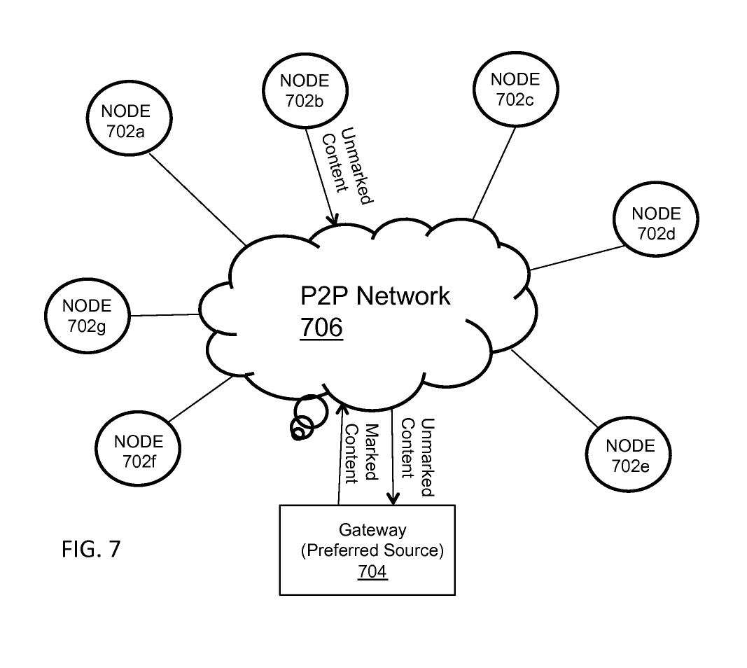

In some implementations, the host device 102 take the form of a node in a computer system (e.g., a personal computer) that may be part of a P2P network 706, as shown in FIG. 7. In the P2P network 706, various peer nodes 702a through 702g may be seeded with high-quality content, which may be watermarked or tagged with identifiers. The unmarked content may be retrieved from the peer nodes 702a through 702g and sent to a gateway 704. At the gateway 704, CI information may be added to the unmarked content (e.g., content that may be most often pirated) and re-introduced into the P2P network 706, so that the content including the CI information may be copied by other peer nodes 702 in the P2P network 706. For example, a watermark including CI information may be inserted in unmarked content (e.g., a video) retrieved from peer node 702b, then re-introduced back into the same peer node or other peer node 702 in the P2P network 706.

In some implementations, unmarked content may not be extracted from peer nodes 702 in the P2P network 706. Rather, the gateway 704 acts as a “honey pot” of marked content, which may be retrieved by the peer nodes 702. In such an implementation, users will be attracted to the “honey pot” of content, which includes highly desirable content (e.g., new film releases), and will download the marked content to their devices.

In some implementations, the gateway 704 may become a preferred source for watermarked content in the P2P network 706 through the use of pollution and poisoning attacks. For example, the gateway 704, acting as a peer node, may insert fully useable, but watermarked or tagged, files in the P2P network 706. If the watermarked/tagged content is fully useable or of high quality, then the peer ranking for the gateway 704 will increase as the gateway 704 gives more than takes from the P2P network 706, especially if the peer nodes 702 in the P2P network 706 provide poor quality or partially useable content. Content availability, pollution and poisoning in a P2P network is described in Christin, N., et al., “Content Availability, Pollution and Poisoning In File Sharing Peer-to-Peer Networks,” Proceedings of ACM EC '05, Vancouver, British Columbia, Canada, June 2005, which article is incorporated by reference herein in its entirety.

In some scenarios, a content identifier may not be available for some content to be seeded. In those instances, the content needs to be identified before the content may be watermarked or tagged with identifiers. The identification may be done in several ways. In such cases, the unknown content may be correlated to a known content database by comparing the content bit streams. This comparison may be performed on raw data using a sliding window correlation or by comparing hashes, fingerprints or similar content identifiers, which may also use a sliding window. The hashes, fingerprints or similar content identifiers may be custom designed for this purpose based on known hashing technology (e.g., MD5, SHA).

In other implementations, optical character recognition on an image, perhaps in conjunction with audio analysis, may be performed on the first few frames of a video, image or audio content, where the title may be read perhaps in conjunction with the opening music theme may be retrieved and compared against a known content database such as Gracenote.com or Internet movie database so that appropriate advertisements and related materials may be selected and made available to the user of device 102.

This functionality may be included in the reader and run as a transparent background process while content is being downloaded, buffered for streaming or any other suitable time (e.g., during trailers or when copyright information may be displayed). Such a scheme may allow CI information to be created for content that is not in any database (e.g., an independent film). For example, the title page of a film may be read and the title and studio information inserted in the content as part of a watermark payload. Hashes or video, image/audio similarity measures may be sent to the gateway by the reader for a comparison against content databases. For example, the content player could generate its own CI information and add in a watermark without any pre-existing CI information. Such a feature may be useful to Internet Service Providers (ISPs), network companies and the like, as a way to monitor and sanitize pirated content.

In some scenarios, a CI audio watermark created using the scheme described immediately above may be removed from the content if a copy of the unmarked content may be available. For example, the unmarked content may be subtracted from the marked content and the remaining content may be the watermark. The watermark/tag may then be subtracted from marked content. This scenario could be thwarted, however, by randomly offsetting temporally the watermark each time the same content is marked. This way the watermark will be different even if it contains the same CI information and may be provided in the same content.

Once the P2P network is benignly polluted with watermarked, high quality copies of content (e.g., film), P2P users may be offered a high quality media player with a reader that may pick out watermarked/tagged copies of the content from the other pollution or decoys injected into the system. Prior to download or streaming, the reader may sample watermarks/tags randomly throughout the content to ensure that the watermarked content was not attacked or otherwise tampered with. The watermarked/tagged content may also be sampled and compared to good copies in other ways besides checking watermarks (e.g., hash correlation). This would ensure that only good content copies are accepted by the peer node that has the reader installed.

Some advantages of the foregoing implementation are: 1) content pirates have an incentive to install a reader on their peer node because it provides a sanitized copy of content, and 2) the P2P network will eventually be cleared of pirated content, while generating ad fees for content aggregators and preventing the non-monetized dissemination of content.

Various modifications may be made to the disclosed implementations and still be within the scope of the following claims.

What is claimed is:

1. A method comprising:
receiving, by way of a host device, a request to pause playback of content;
the host device displaying an input area; and
the host device accepting an annotation entered into the input area by the user and conveying the annotation to a content interactivity gateway.

2. The method of claim 1, further comprising:
the host device displaying a user interface element capable of being placed at a user selectable location on a display of the host device, the host device displaying the user interface element prior to the host device displaying the input area.

3. The method of claim 2, wherein upon locating the user interface element, at a particular location on the display, contextual information within a stack is displayed in addition to the input area.

4. The method of claim 3, further comprising displaying advertising within the stack displayed in the input area.

5. The method of claim 1, further comprising:
the host device displaying controls immediately following receiving the request to pause playback.

6. The method of claim 1, further comprising:
the host device displaying annotations from at least one other user.

7. A method of operating a content interactivity gateway, comprising:
receiving an indication that a first host device has paused content playback;
receiving an indication that a user interface element has been selected on the first host device; and
receiving an annotation relevant to the selected user interface element entered during the pause.

8. The method of claim 7, further comprising:
determining that the received annotation is inappropriate; and
deleting the inappropriate received annotation.

9. The method of claim 7, further comprising:
conveying the annotation to a second host device.

10. The method of claim 7, further comprising:
conveying advertising relevant to the selected user interface element to the first host device.

11. The method of claim 10, wherein the first host device is directed to display the advertising and the annotation in a stacked configuration.

12. The method of claim 7, wherein the annotation pertains to contextual information.

13. The method of claim 17, wherein the first host device is directed to display contextual information and advertising information in a stacked configuration.

14. The method of claim 13, wherein the contextual information includes a user-supplied link.
